(19) United States
(12) Patent Application Publication
(10) Pub. No.: US 2015/0315919 A1
(43) Pub. Date: Nov. 5, 2015

(54) LIGHTWEIGHT STRUCTURAL NiAl ALLOY WITH A HIGH HIGH-TEMPERATURE STRENGTH

(71) Applicant: MTU Aero Engines AG, Munich (DE)

(72) Inventor: Wilfried SMARSLY, Munich (DE)

(21) Appl. No.: 14/341,955

(22) Filed: Jul. 28, 2014

(30) Foreign Application Priority Data
Jul. 29, 2013 (DE) 102013214767.8

(51) Int. Cl. F01D 5/28; F01D 9/02; C22C 19/03

(52) U.S. Cl. CPC F01D 5/28; C22C 19/03; F01D 9/02; F05D 2220/30; F05D 2300/177

(57) ABSTRACT

Disclosed is a material on the basis of intermetallic nickel aluminides for applications which require a high high-temperature strength. The material comprises more than 50 at. % nickel and ternary Laves phases. Also disclosed is a component of a turbomachine produced from the material.

### CROSS-REFERENCE TO RELATED APPLICATIONS

The present application claims priority under 35 U.S.C. §119 of German Patent Application No. 102013214767.8, filed Jul. 29, 2013, the entire disclosure of which is expressly incorporated by reference herein.

### BACKGROUND OF THE INVENTION

1. Field of the Invention

The present invention relates to a material which can be used in particular for applications in which a high high-temperature strength is required. In addition, the present invention relates to a component of a turbomachine, in particular of an aero engine, of a corresponding material.

2. Discussion of Background Information

In turbomachines, such as stationary gas turbines or aero engines, certain components, for example rotor blades of the turbine region and in particular of the low-pressure turbine region, are subject to operating conditions which place high demands on the corresponding materials. Therefore, the materials on the one hand have to withstand high temperatures in the range of, for example, 800° C. to 1200° C., and additionally have to bear high levels of mechanical loading, for example rotor blades which are moved at high rotational speeds. Particular demands are placed on the high-temperature strength and creep strength of corresponding materials by the combination of high operating temperatures and high mechanical forces.

However, the nickel-base superalloys which are used at present for corresponding applications, for example MAR M 247 (trade name of the company Martin Marietta), IN 100 (trade name of the company Special Metals) or CMSX 4 (trade name of the company Cannon Muskegon), have the disadvantage that the specific weight is relatively high, and therefore corresponding components have a high weight, which is disadvantageous for applications in the construction of aero engines.

In addition, in the case of these known materials, further improvements in the performance of the turbomachines by suitably increasing the rotational speeds and/or increasing the operating temperature can only be achieved by either accepting a reduction in the service life of the component or an increase in the component weight or providing separate component cooling. However, all of these measures increase the corresponding outlay and the costs.

Accordingly, attempts have already been made firstly to reduce weight and secondly to increase the material properties in terms of strength, creep strength and high-temperature strength by using different materials. Potential materials which have been taken into consideration for this purpose are intermetallic compounds, which, on account of their special bond properties, have a high strength and can be formed from chemical elements having a low atomic weight.

Nickel-aluminum alloys on the basis of the intermetallic compound NiAl are a material which appears to be suitable. Examples of these are given in U.S. Pat. No. 5,935,349 and also in the scientific articles B. Zeumer, G. Sauthoff, Intermetallic

NiAl—Ta alloys with strengthening Laves phase for high-temperature applications I. Basic properties, Intermetallics 5 (1997) 563-577 and B. Zeumer, G. Sauthoff, Deformation behaviour of intermetallic NiAl—Ta alloys with strengthening Laves phase for high-temperature applications II. Effects of alloying with Nb and other elements, Intermetallics 5 (1997) 641-649. The alloys described in these publications, the entire disclosures of which are incorporated by reference herein, comprise up to 50 at. % Ni and ternary Laves phases.

Although good results in terms of the high-temperature strength and creep strength have already been achieved thereby, there is a further need to provide materials which are advantageous in terms of creep strength and high-temperature strength and also the specific weight for use in the construction of aero engines.

It would therefore be advantageous to be able to provide a material which is suitable for high-temperature applications owing to a high high-temperature strength and creep strength and at the same time has a low specific weight, in order to keep the component weight for components made of this material low or to reduce it. In addition, it should be possible for the material to be produced and processed easily and effectively.

### SUMMARY OF THE INVENTION

The present invention provides a material on the basis of intermetallic nickel aluminides for applications which require a high high-temperature strength. The material comprises more than 50 at. % nickel and ternary Laves phases.

In one aspect, the material may comprise NiAl and/or Ni₃Al.

In another aspect, the material may comprise ternary Laves phases on the basis of Ni, Al and Ta and/or Nb, in particular, one or more of NiAlTa, NiAlNb and NiAl(Ta,Nb).

In yet another aspect, the material may comprise from 50.1 at. % to 70 at. % Ni, e.g., from 51 at. % to 60 at. % Ni, and from 0.5 at. % to 10 at. % Ta, e.g., from 1 at. % to 5 at. % Ta and/or from 0.5 at. % to 10 at. % Nb, e.g., from 1 at. % to 5 at. % Nb, remainder aluminum.

In a still further aspect of the material, some of the aluminum may be replaced by impurities, accompanying elements and/or further alloying elements.

In another aspect of the material, the sum total of Ta and Nb in the material may be from 0.5 at. % to 10 at. %, e.g., from 1 at. % to 5 at. %.

In another aspect of the material, the microstructure thereof may comprise NiAl crystallites and/or Ni₃Al crystallites, at the grain boundaries of which are arranged ternary Laves phases.

The present invention also provides a component of a turbomachine, which component is formed from, or comprises the material of the present invention as set forth above, including the various aspects thereof.

In one aspect, the component may be a component of an aero engine. For example, the component may be a rotor blade or a guide vane in a turbine, in particular in a low-pressure turbine of a turbomachine.

The invention is based on the recognition that the Ni—Al alloys described in the prior art can be improved further with respect to their property profile for high-temperature applications and in particular for applications in the field of turbomachines, such as aero engines, if the nickel proportion is increased above a proportion of 50 at. % Ni. Accordingly, the invention proposes a material on the basis of intermetallic nickel aluminides which comprises more than 50 at. % Ni and ternary Laves phases.

The intermetallic nickel aluminides can be formed by NiAl and/or Ni₃Al, it being possible for the ternary Laves phases to be formed on the basis of Ni, Al and Ta and/or Nb.

In particular, the material can comprise ternary Laves phases in the form of NiAlTa, NiAlNb and/or NiAl(Ta,Nb), it being possible in the case of the ternary Laves phase NiAl(Ta,Nb) for the constituents tantalum and niobium to be present in mixed form and, since tantalum and niobium can mutually replace one another, for the respective proportions of tantalum and niobium to vary within a wide range of different compositions.

Owing to their presence at the corresponding grain boundaries of the NiAl crystallites and/or the Ni₃Al crystallites, the ternary phases on the basis of Ni, Al and Ta and/or Nb ensure that there is a corresponding increase in the strength and the creep strength of the material. Ternary Laves phases of this type can be in the form of the hexagonal C14 structure, whereas NiAl is present in the B2 structure.

In particular, the material can comprise 50.1 to 70 at. % Ni, preferably 51 at. % to 60 at. % Ni and 0.5 at. % to 10 at. % Ta, in particular 1 at. % to 5 at. % Ta. In addition or as an alternative to tantalum, the material can comprise 0.5 at. % to 10 at. % Nb, in particular 1 at. % to 5 at. % Nb, the remainder being formed by aluminum Tantalum and niobium can be mutually interchanged in the material, and therefore the sum total of tantalum and niobium can be in the range of 0.5 at. % to 10 at. % and in particular 1 at. % to 5 at. %.

At the expense of the aluminum, the material can contain further alloying constituents, for example chromium, iron, hafnium, molybdenum, carbon, silicon, titanium, vanadium, zirconium and also impurities and accompanying elements.

Components of turbomachines and preferably of aero engines in particular can be formed from or contain the corresponding material. Above all, it is expedient to use the material according to the invention for rotor blades or guide vanes in the turbine of a turbomachine, in particular the low-pressure turbine.

### EXEMPLARY EMBODIMENT

By way of example, it is possible to use a material comprising 60 at. % nickel, 2.5 at. % tantalum and 2.5 at. % niobium as well as 35 at. % aluminum which, through the microstructure formation with NiAl and Ni₃Al and also ternary Laves phases at the grain boundaries of the NiAl and Ni₃Al grains, has a high high-temperature strength and creep strength combined with a low specific weight.

While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed is:

1. A material on the basis of intermetallic nickel aluminides for applications which require a high high-temperature strength, wherein the material comprises more than 50 at. % nickel and ternary Laves phases.

2. The material of claim 1, wherein the material comprises NiAl and/or Ni₃Al.

3. The material of claim 1, wherein the material comprises ternary Laves phases on the basis of Ni, Al and Ta and/or Nb.

4. The material of claim 3, wherein the material comprises one or more of NiAlTa, NiAlNb and NiAl(Ta,Nb).

5. The material of claim 1, wherein the material comprises from 50.1 at. % to 70 at. % Ni, and from 0.5 at. % to 10 at. % Ta and/or from 0.5 at. % to 10 at. % Nb, remainder aluminum.

6. The material of claim 1, wherein the material comprises from 51 at. % to 60 at. % Ni and from 1 at. % to 5 at. % Ta and/or from 1 at. % to 5 at. % Nb, remainder aluminum.

7. The material of claim 5, wherein the material comprises from 51 at. % to 60 at. % Ni.

8. The material of claim 5, wherein the material comprises from 1 at. % to 5 at. % Ta and/or from 1 at. % to 5 at. % Nb

9. The material of claim 1, wherein some of the aluminum is replaced by impurities, accompanying elements and/or further alloying elements.

10. The material of claim 5, wherein the sum total of Ta and Nb in the material is from 0.5 at. % to 10 at. %.

11. The material of claim 5, wherein the sum total of Ta and Nb in the material is from 1 at. % to 5 at. %.

12. The material of claim 6, wherein the sum total of Ta and Nb in the material is from 0.5 at. % to 10 at. %.

13. The material of claim 6, wherein the sum total of Ta and Nb in the material is from 1 at. % to 5 at. %.

14. The material of claim 7, wherein the sum total of Ta and Nb in the material is from 1 at. % to 5 at. %.

15. The material of claim 1, wherein a microstructure of the material comprises NiAl crystallites and/or Ni₃Al crystallites, at the grain boundaries of which are arranged ternary Laves phases.

16. The material of claim 3, wherein a microstructure of the material comprises NiAl crystallites and/or Ni₃Al crystallites, at the grain boundaries of which are arranged ternary Laves phases.

17. A component of a turbomachine, wherein the component is formed from or comprises the material of claim 1.

18. The component of claim 17, wherein the component is a component of an aero engine.

19. The component of claim 17, wherein the component is a rotor blade or a guide vane in a turbine.

20. The component of claim 19, wherein the component is a rotor blade or a guide vane in a low-pressure turbine of a turbomachine.
